(19) United States
(12) Patent Application Publication
(10) Pub. No.: US 2023/0058411 A1
(43) Pub. Date: Feb. 23, 2023

(54) BUBBLE LETTER IDENTIFICATION APPARATUS

(71) Applicant: Law Office of Jerry Joseph, PLC, Washington, DC (US)

(72) Inventors: Vincent Williams, Baltimore, MD (US); Santha Siegel, Baltimore, MD (US)

(21) Appl. No.: 17/892,540

(22) Filed: Aug. 22, 2022

Related U.S. Application Data
(60) Provisional application No. 63/235,479, filed on Aug. 20, 2021.

(51) Int. Cl. G09F 9/40; G09F 23/00

(52) U.S. Cl. CPC G09F 9/40; G09F 23/0066

(57) ABSTRACT

A lettering kit including a plurality of character members corresponding to every letter of the alphabet, each character member comprises a hinge portion between a first portion and a second portion, wherein the hinge portion allows the first portion to move between a first open position and a second closed position.

### BACKGROUND OF THE INVENTION

### 1. Field of the Invention

The exemplary embodiments relate to an apparatus used for identification purposes. Specifically, the exemplary embodiments relate to an identification apparatus for eyewear including, but not limited to, swim googles, sports goggles, and other active or leisure eyewear.

### 2. Description of Related Art

There have been previous means for identification of eyewear. For example, individuals would often indicate the identity of the owner of the eyewear by writing an identifier on a strap or band of the eyewear with markers or other permanent ink dispensers. In other instances, individuals often applied stickers or labels to a portion of the eyewear strap or band to identify the owner. However, these methods fail as an acceptable identifying means because the ink eventually fades or the sticker or label is eventually lost due to the constant and repeated submersion in chlorinated water, salt water, and/or exposure to heat and ultra-violent (UV) light from the sun.

Therefore, what is desired is an identification apparatus for easy and quick identification of eyewear that is suitable for long term use. For example, the identification apparatus includes symbols that are removably fixable to at least a portion of the eyewear, or the strap or band thereof. In certain exemplary embodiments, the identification apparatus comprises 3D bubble letters that are operatively open and closeable around the strap or band of the eyewear and that remain fixed to the eyewear during use thereof. The exemplary bubble letters are flat enough to maintain the eyewear strap or band snug against the users head. In such exemplary embodiments, the bubble letter apparatus is comprised of a waterproof material such as silicone or polymer. In addition, to aesthetically enhance the bubble letter apparatus, the bubble letters may be of varying colors of the solid of multi-color type.

### SUMMARY OF THE INVENTION

Certain of the foregoing and related aspects are readily attained according to the present general inventive concept by providing a lettering kit including a plurality of character members corresponding to every letter of the alphabet, each character member comprises a hinge portion between a first portion and a second portion, wherein the hinge portion allows the first portion to move between a first open position and a second closed position.

The lettering kit may include an attachment member coupled to at least one of the first portion and the second portion configured to detachably couple the first portion to the second portion.

The attachment member may include a magnet or other means for mechanical attachment.

The character member may be configured to receive a strap when the first portion is at the first open position and securely fastened to the strap when the first portion is at the second closed position.

The first portion may include a notch configured to receive the strap and allow the first portion to sit flush with the second portion when moved to the second closed position.

The hinge portion may be a living hinge integrally formed with the first portion and the second portion.

The hinge portion may be formed of a flexible material.

The character members may be formed of at least one of a buoyant material, a photoluminescent, a silicone, and mixtures thereof.

The attachment member may include a first attachment portion which is detachably coupled to a second attachment portion.

### BRIEF DESCRIPTIONS OF THE DRAWINGS

These and/or other aspects of the exemplary embodiments will become apparent and more readily appreciated from the following description taken in conjunction with the accompanying drawings of which:

FIG. 1 is a front view of the exemplary identification apparatus in an open position;

FIG. 2 is an upper right front perspective view of the exemplary identification apparatus in an open position;

FIG. 3 is a left side plan view of the exemplary identification apparatus in an open position;

FIG. 4 is an upper right front perspective view of the exemplary identification apparatus in a closed position;

FIG. 5 is a front plan view of the exemplary apparatus;

FIG. 6 is a front view of a character member corresponding to the letter ‘N” according to an embodiment of the present general inventive concept;

FIG. 7 is a right-side view of the character member illustrated in FIG. 6;

FIG. 8 is a top view of the character member illustrated in FIG. 6;

FIG. 9 is a cross-sectional view of the character member illustrated in FIG. 6 along line C-C in FIG. 8; and

FIG. 10 is an enlarged detail view of a hinge member of the character member illustrated in FIG. 9.

### DESCRIPTION OF INVENTION

Reference will now be made in detail to the exemplary embodiments, examples of which are illustrated in the accompanying drawings, wherein like reference numerals refer to the like elements throughout. The exemplary embodiments are described below with reference to the figures.

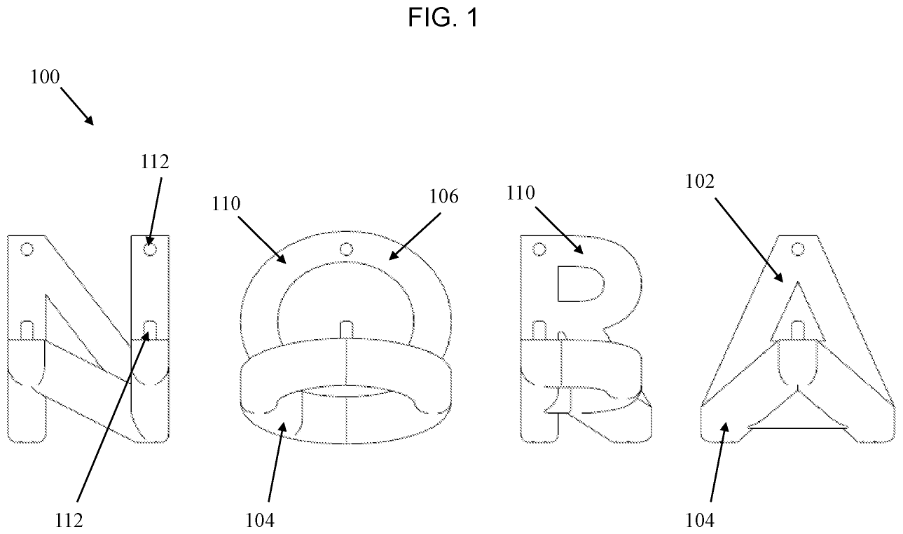

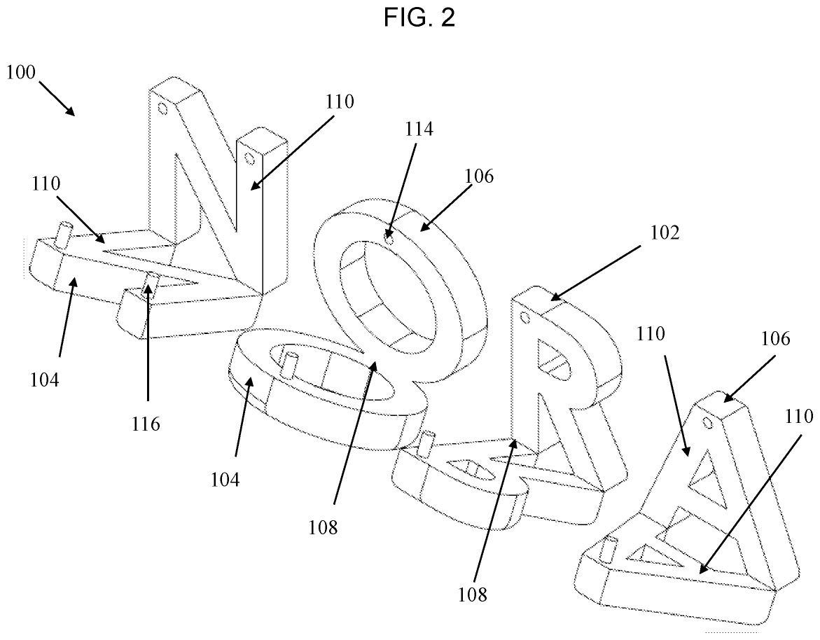

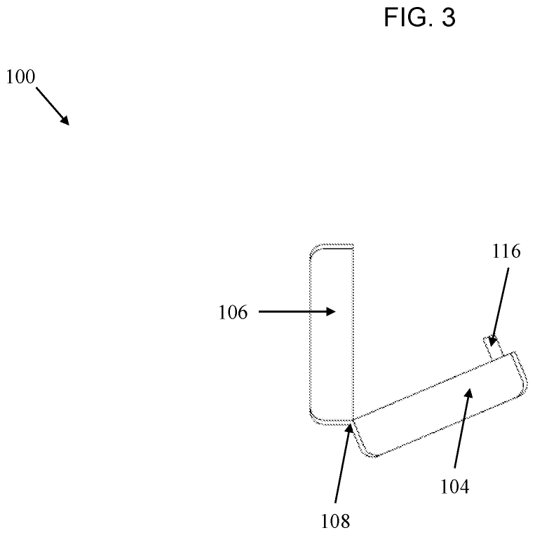

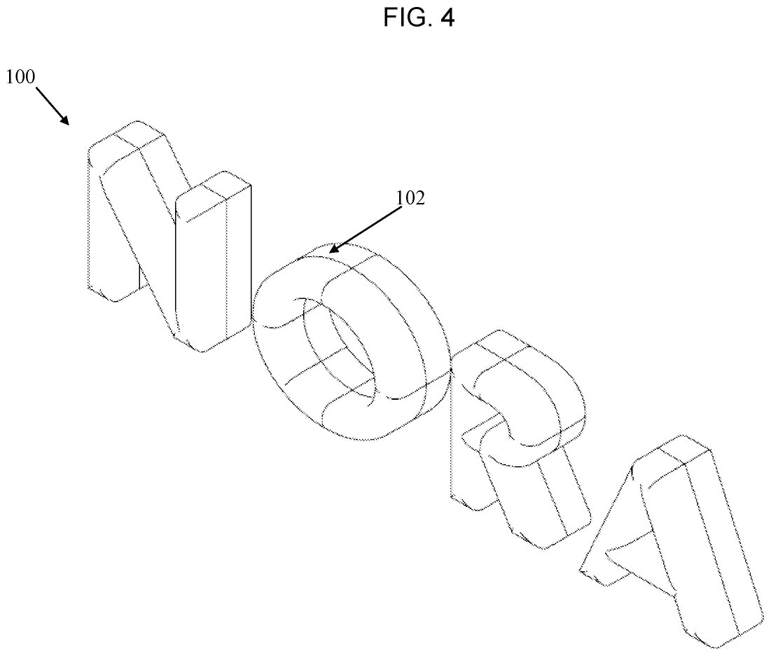

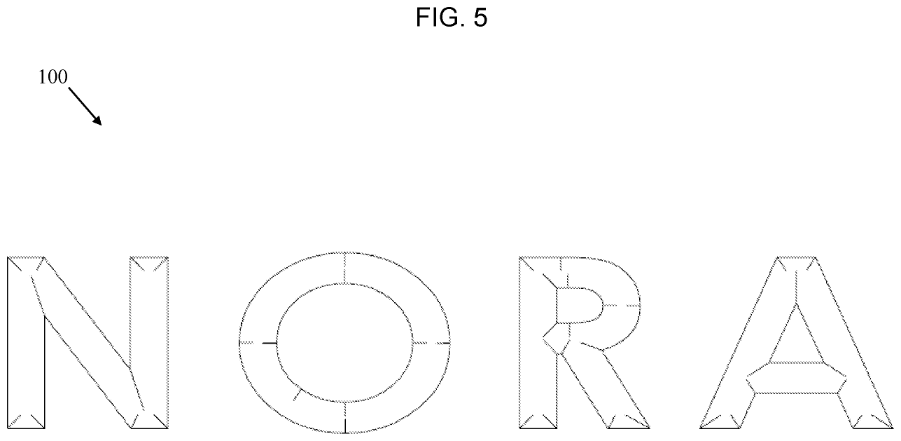

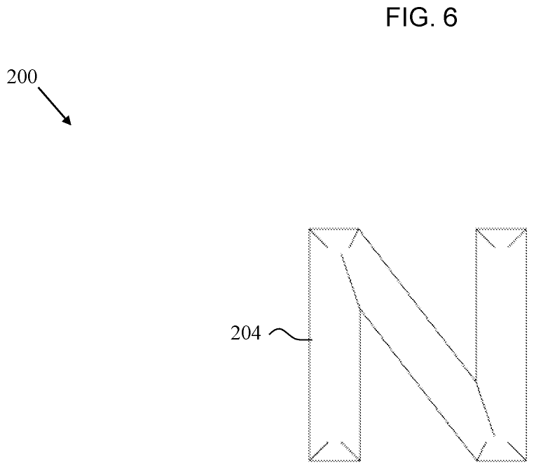

FIG. 1 is a front view of the exemplary identification apparatus in an open position, FIG. 2 is an upper right front perspective view of the exemplary identification apparatus in an open position, FIG. 3 is a left side plan view of the exemplary identification apparatus in an open position, FIG. 4 is an upper right front perspective view of the exemplary identification apparatus in a closed position, FIG. 5 is a front plan view of the exemplary identification apparatus, and FIG. 6 is a right side plan view of the exemplary identification apparatus in a closed position.

Referring to FIGS. 1 through 6, the exemplary identification apparatus, designated generally as 100, is illustrated. In the present exemplary embodiment, the exemplary apparatus 100 is configured to be removably attachable to a portion of eyewear (not shown), for example, a strap or band of swim goggles, sports goggles, or other eyewear. The exemplary apparatus 100 is configured such that it is movable between an open position and a closed position. In the exemplary open position, the exemplary apparatus is able to permit the eyewear strap or band to be positioned in an operative position such that when the apparatus 100 is moved to the closed position, the strap or band is held in engagement with the apparatus. In the exemplary closed position, the exemplary apparatus is held fixed to the strap or band of the eyewear.

In the present exemplary embodiment, the exemplary apparatus 100 includes at least one identifying symbol 102, such as a letter, number, or other character. However, identifying symbol 102 may alternatively comprise other shapes or objects as well. Each exemplary identifying symbol 102 has a structure that is configured to be movable between the open and closed positions such that the identifying symbol 102 can be securely attached to at least a portion of the eyewear strap or band when in the closed position, and to be removable from the eyewear strap or band when in the open position. In exemplary arrangements, numerous identifying symbols are attached to the eyewear strap or band to form a unique identifier that a user is able to recognize for easy and quick retrieval of the eyewear associated with the apparatus. However, the exemplary embodiments are not limited thereto.

In exemplary embodiments, the at least one identifying symbol 102 includes a front portion 104 and a back portion 106. The exemplary front portion 104 and back portion 106 of the identifying symbol 102 are in operative connection with one another and are movable relative to one another. In some exemplary embodiments, the front portion 104 and back portion 106 are movably mounted on at least one hinge 108. The exemplary hinge 108 permits the front portion 104 and the back portion 106 to move relative to one another, while maintaining a durable connection point between the front and back portions. However, the present exemplary embodiments are not limited thereto.

In alternative exemplary embodiments, the front portion 104 and the back portion 106 of the identifying symbol 102 are integrally formed at either a top end or bottom end of the identifying symbol 102. At the point of integral formation, there is at least a portion of each of the front portion 104 and the back portion 106 that is comprised of a durable and flexible material that permits relative movement of the front and back portions. In these alternative exemplary embodiments, the front portion 104 and the back portion 106 are configured to be movable relative to one another such that the identifying symbol 102 is movable between the open and closed positions.

As shown in FIGS. 1, 2, and 3, the front portion 104 and back portion 106 of the identifying symbol 102 are movable to an open position. As shown in FIG. 4, the front portion 104 and back portion 106 of the identifying symbol 102 are movable to a closed position.

The exemplary front portion 104 and back portion 106 of the identifying symbol 102 each include an inner face 110. The exemplary inner face 110 of each of the front portion 104 and back portion 106 are in aligned, facing relation to each other when the front and back portions are in the exemplary closed position. In the open position, the exemplary inner faces 110 of the front and back portions are disposed away from each other.

In the exemplary open position, the inner face 110 of the front portion 104 is disposed apart from the inner face 110 of the back portion 106 such that the strap or band of eyewear may be position between the inner faces 110 of the front and back portions. In the exemplary closed position, the inner face 110 of the front portion 104 of the identifying symbol is in close adjacent relation, or in some instances, abutting relation, to the inner face 110 of the back portion 106 such that the eyewear strap or band that is positioned therebetween (when the portions are in the closed position), is securely grasped or pinched between the inner faces 110 of the front portion 104 and back portion 106.

In alternative exemplary embodiments, each of the inner faces 110 includes a notch (not shown) between an upper portion and lower portion of the inner faces 110. The exemplary notch extends inward in the inner face 110 and extends longitudinally between the upper and lower portions of the inner faces 110. The exemplary notch is configured to accept the eyewear strap or band such that the strap or band is relatively longitudinally immovable in relation to the inner faces 110 of the front portion 104 and back portion 106.

In still other alternative exemplary embodiments, one of the front portion 104 and the back portion 106 includes an elongated loop or ring (not shown) that bounds an elongated strap or band opening. The exemplary elongated loop extends between the upper portion and the lower portion of the inner face 110. The other of the front and back portions of the identifying symbol 102 includes an elongated slot (not shown) that is configured to enable the elongated loop to extend into the elongated slot of the opposite portion when in the closed position. The exemplary elongated opening is configured such that the strap or band of the eyewear is enabled to be strung therethrough, and to ensure that the strap is relatively longitudinally immovable in relation to the inner faces 110 of the front and back portions.

In still other exemplary embodiments, the inner faces 110, the notch, or elongated opening may include gripping pads, clasps, or similar to prevent lateral movement of the eyewear strap or band relative to the inner faces 110 of the front and back portions.

In the exemplary embodiments, each of the identifying symbols 102 includes at least one releasable connector 112. The exemplary releasable connector 112 is sufficient to hold the identifying symbol 102 in the closed position with the strap or band securely grasped or pinched between the inner faces 110 of the front portion 104 and back portion 106.

In exemplary arrangements of the releasable connector 112, the at least one releasable connector 112 is comprised of at least one recess 114 and at least one projection 116. The exemplary recess 114 is operatively positioned on one of the front portion 104 and the back portion 106 of the identifying symbol 102. The exemplary projection 116 is operatively positioned on the other of the front portion 104 and the back portion 106 that does not include the recess 114.

The exemplary recess 114 and projection 116 are in operatively aligned relation such that when the identifying symbol 102 is moved from the open position to the closed position, the projection 116 is enabled to slide into the recess 114 permitting the adjacent or abutting relation of the inner faces 110 of the front portion 104 and back portion 106. The exemplary recess 114 and projection 116, when engaged with one another, are configured to operatively resist movement of the identifying symbol 102 from the closed position to the open position until enough separation force is applied. However, the recess and projection arrangement is merely an example of the releasable connector 112, and other releasable connector arrangements may be used.

In alternative exemplary embodiments, the exemplary front portions 104 and back portion 106 of the identifying symbol 102 may be held together in the closed position by other types of releasable connectors 112. For example, other types of releasable connectors may include magnets, adhesives, clamps, clasps, latches, hook and loop structures, snaps, or other releasable engaging structures sufficient to maintain the identifying symbol 102 in the closed position, and that also permit movement of the of the front and back portions of the identifying symbol to the open position when sufficient force is applied, or a release mechanism is operated to cause disengagement.

In still further alternative exemplary embodiments, the exemplary releasable connector 112 comprises structures that are operative to pierce or extend through the material of the eyewear strap or band and to engage a receiving structure on the other side of the strap or band to prevent lateral and/or longitudinal movement of the strap or band relative to the inner faces 110. Other alternative exemplary embodiments are configured such that the front and back portions only surround part of the eyewear strap or band in the closed position of the identifying symbol. In such alternative embodiments, the exemplary apparatus is held closed by pressure clamps that are operative to clamp around or securely pinch at least a portion of the strap or band material, thereby preventing relative movement of the strap or band.

In the present exemplary embodiment, the front portion 104 and the back portion 106 of the identifying symbol 102 are connected to one another. However, the present inventive concept is not limited thereto. That is, in alternative exemplary embodiments, the exemplary front portion 104 and back portion 106 of the identifying symbol 102 may be completely separate pieces that are simultaneously enclosed around the strap or band. In such alternative exemplary embodiments, in the open position of the identifying symbol 102, the front portion 104 and back portion 106 are completely removed from one another. Additionally, each identifying symbol 102 of such alternative exemplary embodiments may include numerous releasable connectors 112 to ensure that all areas of the identifying symbol are sufficiently held in the closed position, thereby promoting secure grasping or pinching of the eyewear strap or band between the front portion 104 and back portion 106. This multiple releasable connector approach is helpful to prevent slipping of the strap or band between the front and back portions, as well as preventing unintentional disengagement of the front and back portions, in the event that one of the releasable connectors is compromised.

In the present exemplary embodiment, each of the exemplary identifying symbols 102 is comprised of a flexible and durable material that is operative to withstand extreme heat or the absence thereof, as well withstand extended exposure to ultra-violent light. For example, in some exemplary embodiments, the exemplary identifying symbols 102 are comprised of silicone or a flexible, soft polymer. In other exemplary embodiments, the exemplary identifying symbols 102 are comprised of a more rigid material such as a rigid polymer, wood, or metal. Additionally, in alternative exemplary embodiments, the material comprising the identifying symbols 102 may include buoyant properties or features such that the eyewear is caused to float when submerged in water.

In the present exemplary embodiment, the exemplary identifying symbols 102 are configured such that they lay flat against a user's head when the identifying symbols are in the closed position and secured around the strap or band of the eyewear. In alternative exemplary embodiments, the identifying symbols 102 may include pads or other soft material that are waterproof and resistant to extended extreme heat, cold, and UV exposure. The exemplary pads are attached to the identifying symbols and are disposed between the identifying symbol and the user's head. Such pads or other soft material facilitate comfortability for the user when the eyewear is in use and the identifying symbols are installed.

In still further alternative exemplary embodiments, the exemplary identifying symbols 102 may be integrally or releasably connected to other identifying symbols via manufacturing molding techniques, chains, ropes, or other linking material. The exemplary connection between the identifying symbols is sufficient to string together multiple identifying symbols 102 to form a user's unique identifier such as a name, slogan, numerical code, or other identifier. Of course, the unique identifiers may include numerous identifying symbols 102 that are not connected to one another.

It should be understood that while the exemplary embodiments herein have been described in use with eyewear, the exemplary embodiments may be useful for identification of other objects in need of quick and easy retrieval. For example, the exemplary embodiments may be useful for straps of marching band instruments, key lanyards, as well as many other objects.

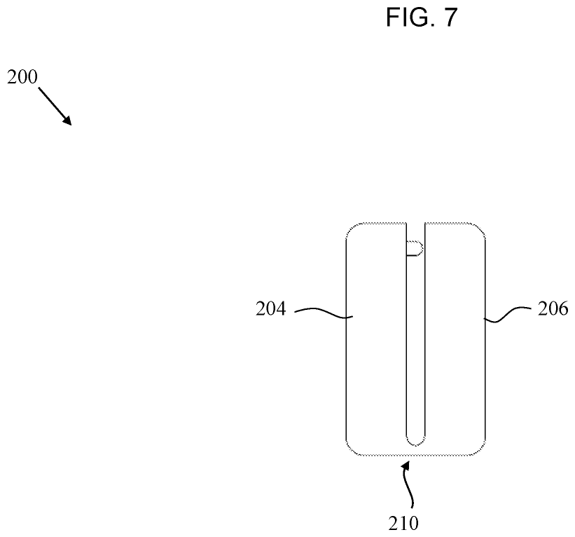

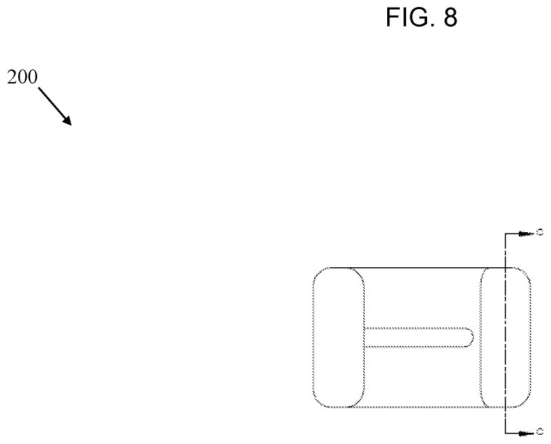

FIG. 6 is a front view of a character member corresponding to the letter ‘N” according to another embodiment of the present general inventive concept. FIG. 7 is a right-side view of the character member illustrated in FIG. 6 and FIG. 8 is a top view of the character member illustrated in FIG. 6.

Referring to FIG. 6, according to another embodiment, the character member is designated generally as 200. In the present exemplary embodiment, the character member 200 includes a first portion 204 (i.e., a front portion) and a second portion 206 (i.e., a back portion). The character member 200 is substantially similar to the previous embodiment and further includes a hinge member 210 disposed between the first portion 204 and the second portion 206. The hinge member 210 may be integrally formed with the first and second portion 204, 206 of the character member 200 and configured to allow the first portion 204 to move between a first open position and a second closed position with respect to the second portion 204.

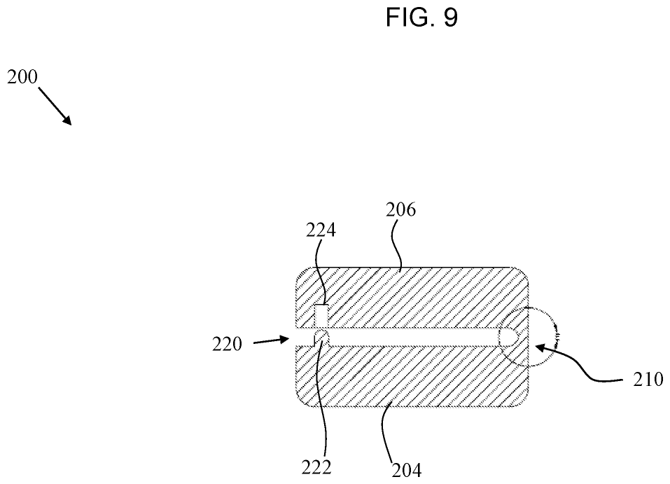

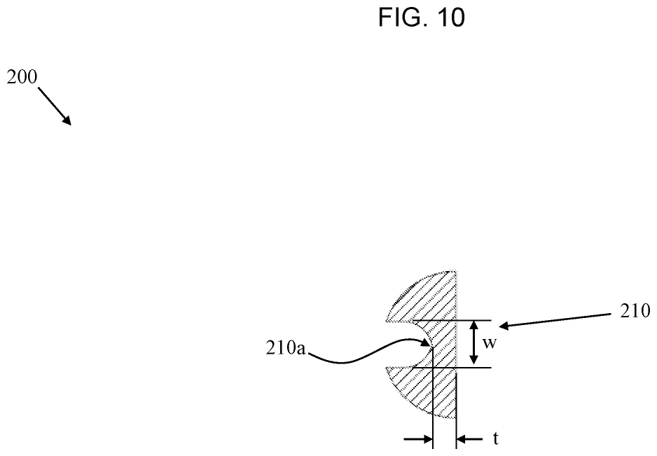

FIG. 9 is a cross-sectional view of the character member illustrated in FIG. 6 along line C-C in FIG. 8 and FIG. 10 is an enlarged detail view of the character member illustrated in FIG. 9.

Referring to FIG. 9, the character member 200 includes an attachment member 220 configured to detachably couple the first portion 204 from the second portion 206. In the present embodiment, the attachment member 220 includes a first attachment portion 222 (i.e., a protrusion) formed within the first portion 204 which is detachably coupled into a second attachment portion 224 (i.e., a recess) formed within the second portion 206. However, the present general inventive concept is not limited thereto.

Referring to FIG. 10, the hinge member 210 is formed with a curved top portion 210a to relieve stress within the hinge member 210 when the first portion 204 is moved from the first position to the second position. The hinge member 210 has a width “w” between 0.125 inches and 0.5 inches and a thickness “t” between 0.125 and 0.65 inches.

Although a few exemplary embodiments have been illustrated and described, it will be appreciated by those skilled in the art that changes may be made in these exemplary embodiments without departing from the principles and spirit of the disclosure, the scope of which is defined in the appended claims and their equivalents.

What is claimed is:

1. A lettering kit comprising:
a plurality of character members corresponding to every letter of the alphabet, each character member comprises a hinge portion between a first portion and a second portion,
wherein the hinge portion allows the first portion to move between a first open position and a second closed position.

2. The lettering kit of claim 1, further comprising an attachment member coupled to at least one of the first portion and the second portion configured to detachably couple the first portion to the second portion.

3. The lettering kit of claim 2, wherein the attachment member includes a magnet.

4. The lettering kit of claim 2, wherein the character member is configured to receive a strap when the first portion is at the first open position and securely fastened to the strap when the first portion is at the second closed position.

5. The lettering kit of claim 4, wherein the first portion includes a notch configured to receive the strap and allow the first portion to sit flush with the second portion when moved to the second closed position.

6. The lettering kit of claim 2, wherein the hinge portion is a living hinge integrally formed with the first portion and the second portion.

7. The lettering kit of claim 6, wherein the hinge portion is formed of a flexible material.

8. The lettering kit of claim 7, wherein the character members are formed of at least one of a buoyant material, a photoluminescent, a silicone, and mixtures thereof.

9. The lettering kit of claim 4, wherein the attachment member includes a first attachment portion which is detachably coupled to a second attachment portion.
